(19) United States
(12) Patent Application Publication
(10) Pub. No.: US 2026/0140550 A1
(43) Pub. Date: May 21, 2026

(54) DAMPING STRUCTURE AND ELECTRONIC DEVICE

(71) Applicants: INVENTEC (PUDONG) TECHNOLOGY CORPORATION, Shanghai (CN); INVENTEC CORPORATION, Taipei City (TW)

(72) Inventors: Hsin-Haou HUANG, Taipei City (TW); Pin-Chieh CHEN, Taipei City (TW); Po-Hsiu CHEN, Taipei City (TW); Hsieh-Liang TSAI, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 19/223,156

(22) Filed: May 30, 2025

(30) Foreign Application Priority Data
Nov. 20, 2024 (CN) 202411669318.9

(51) Int. Cl. G06F 1/18

(52) U.S. Cl. CPC G06F 1/187; G06F 1/181

(57) ABSTRACT

An electronic device includes a chassis, a hard disk drive, at least one fan and at least one damping structure. The hard disk drive is disposed in the chassis. The at least one fan is disposed in the chassis. The at least one damping structure is located between the hard disk drive and the at least one fan, and includes a frame, a flexible film and a mass block. The frame is disposed in the chassis. The flexible film is disposed on the frame. A periphery of the flexible film is connected to the frame. The mass block is disposed on the flexible film. The frame surrounds the mass block.

### CROSS-REFERENCE TO RELATED APPLICATIONS

This non-provisional application claims priority under 35 U.S.C. § 119 (a) on Patent Application No(s). 202411669318.9 filed in China, on Nov. 20, 2024, the entire contents of which are hereby incorporated by reference.

### BACKGROUND OF THE INVENTION

### Technical Field of the Invention

The invention relates to a damping structure and an electronic device, more particularly to a damping structure and an electronic device including a frame, a flexible film and a mass block.

### Description of the Related Art

With the rapid development of technology, the computation performance of processors of an electronic product is improved significantly, while a large amount of heat is generated thereby at the same time. In order to prevent the damage to the processors caused by such heat, a fan is generally provided in the electronic product to cool the processors, so that the processors can operate within an adequate temperature range.

The fan operating in a high speed may generate vibration. When such vibration is transferred to a hard disk drive disposed in the electronic product, a position error signals (PES) may be caused in the operating hard disk drive, thereby adversely affecting an accuracy of data reading and causing a poor read speed of the hard disk drive, for example, causing a low input/output per second (IOPS). Accordingly, an overall performance of the electronic product may be degraded, and data loss may even be caused. Thus, a vibration suppression is critical in the field of the electronic product. Generally, manufactures may additionally assemble a damping member in a chassis of the electronic product to absorb the vibration generated by the fan. However, the conventional damping member is expensive. In addition, it is hard to assemble the damping member in the chassis due to excessive components of the damping member and limited inner space of the chassis. Moreover, the conventional damping member cannot be compatible with different specifications of the chassis. That is, the manufactures need to adopt different sizes of the damping member for different specifications of the chassis, thereby increasing an assembly cost of the damping member. Therefore, lowering the assembly cost while maintaining the damping effect of the damping member is one of the key issues that researchers need to address.

### SUMMARY OF THE INVENTION

The invention provides a damping structure and an electronic device in order to lower the assembly cost while maintaining the damping effect of the damping structure.

One embodiment of the invention provides a damping structure configured to be disposed in a chassis. The damping structure includes a frame, a flexible film and a mass block. The frame is configured to be disposed in the chassis. The flexible film is disposed on the frame. A periphery of the flexible film is connected to the frame. The mass block is disposed on the flexible film. The frame surrounds the mass block.

Another embodiment of the invention provides an electronic device including a chassis, a hard disk drive, at least one fan and at least one damping structure. The hard disk drive is disposed in the chassis. The at least one fan is disposed in the chassis. The at least one damping structure is located between the hard disk drive and the at least one fan, and includes a frame, a flexible film and a mass block. The frame is disposed in the chassis. The flexible film is disposed on the frame. A periphery of the flexible film is connected to the frame. The mass block is disposed on the flexible film. The frame surrounds the mass block.

According to the damping structure and the electronic device disclosed in the above embodiment, the periphery of the flexible film is connected to the frame, and the mass block is disposed on the flexible film. The natural frequencies of the damping structure can be correspondingly adjusted by adjusting the mass of the mass block. Therefore, the vibrations can be damped by the damping structure of the electronic device effectively under different operating conditions. When one of the natural frequencies of the damping structure matches a vibration frequency of the at least one fan, a resonance will be generated, and the strong amplitude enhancement effect may be generated by the damping structure. The interaction between the vibrations generated by the at least one fan during operation and the flexible film of the damping structure can be conducted along the path in which the vibration is transferred. Specifically, the vibration generated by the at least one fan during operation may be transferred to the flexible film of the damping structure. The flexible film can absorb the vibration effectively, and convert the vibration into kinetic energy of the flexible film. Accordingly, the vibration generated by the at least one fan during operation can be confined within the damping structure to dissipate energy. In addition, the damping structure can be facilitated to be assembled in the limited space between the hard disk drive and the at least one fan and be prevented from interfering with other obstructions disposed in the aforementioned space, and thus, the damping structure can be adaptable to different specifications of the chassis. Accordingly, the assembly cost of the damping structure can be lowered while maintaining the damping effect of the damping structure.

### BRIEF DESCRIPTION OF THE DRAWINGS

The invention will become more fully understood from the detailed description given herein below and the accompanying drawings which are given by way of illustration only and thus are not limitative of the invention and wherein:

FIG. 1 is a plane view of an electronic device in accordance with an embodiment of the invention;

FIG. 2 is a perspective view of one of damping structures of the electronic device in FIG. 1;

FIG. 3 is a plane view of one of the damping structures of the electronic device in FIG. 2; and

FIG. 4 is a cross-sectional view of one of the damping structures of the electronic device in FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the invention, such as technical and scientific terms, have its own meanings and can be comprehended by those skilled in the art, unless the terms are additionally defined in the invention. That is, the terms used in the following paragraphs should be read on the meaning commonly used in the related fields and will not be overly explained, unless the terms have a specific meaning in the invention.

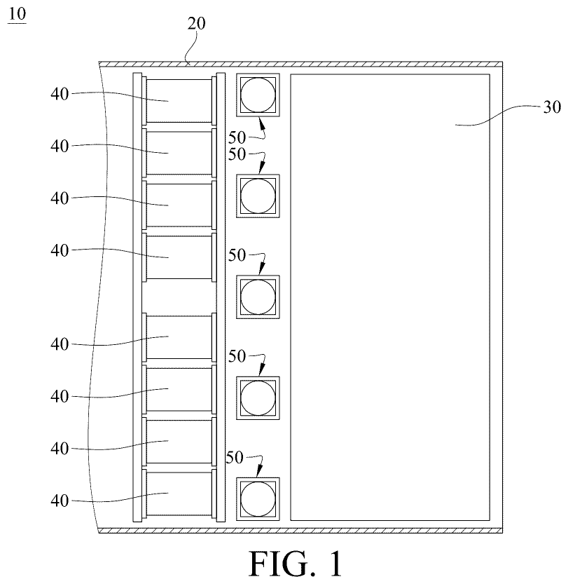

Please refer to FIG. 1, which is a plane view of an electronic device 10 in accordance with an embodiment of the invention. In this embodiment, the electronic device 10 includes a chassis 20, a hard disk drive 30, a plurality of fans 40 and a plurality of damping structures 50. The hard disk drive 30 and the fans 40 are disposed in the chassis 20. The damping structures 50 are disposed between the hard disk drive 30 and the fans 40 as local resonators, such that an interaction between vibrations generated by the fans 40 during operation and the damping structures 50 can be conducted along a path in which the vibrations are transferred. Therefore, the vibrations generated by the fans 40 during operation can be damped. Accordingly, the read speed of the hard disk drive 30, such as input/output per second (IOPS) of the hard disk drive 30, is prevented from being reduced by the vibrations. When a frequency of external vibrations is nearly equal to a resonant frequency of the damping structures 50, a local resonance of the local resonators can be induced to form a vibration bandgap. The local resonance is caused by the interaction between a mass component and elastic waves generated by elastic members of the local resonators, thereby enhancing the vibration suppression effect. In addition, the vibrations of frequency ranging from, for example, 300 hertz (Hz) to 400 Hz and 1200 Hz to 1500 Hz can be absorbed by the damping structures 50. Moreover, a fundamental frequency and overtones thereof around 300 Hz to 400 Hz are, for example, a fundamental frequency of the vibrations generated by the fans 40 during operation, and a frequency ranging from 1200 Hz to 1500 Hz is, for example, a sensitive frequency in which the hard disk drive 30 is susceptible to the vibrations.

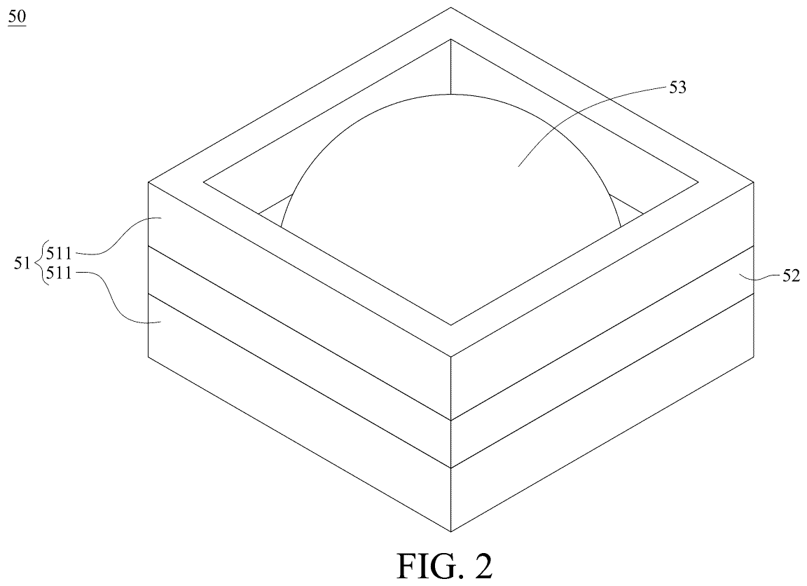

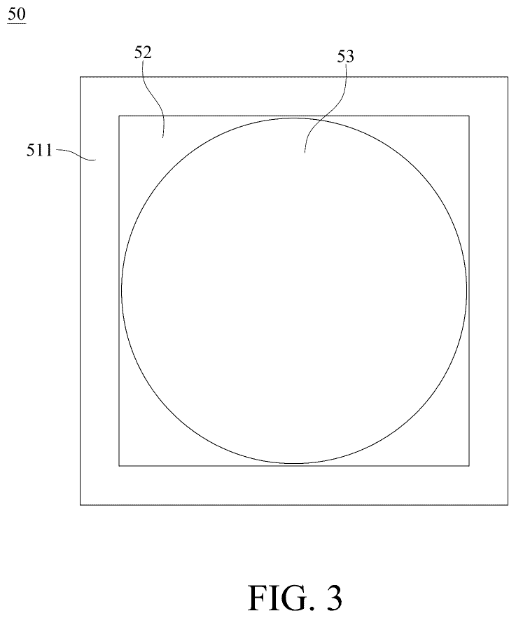

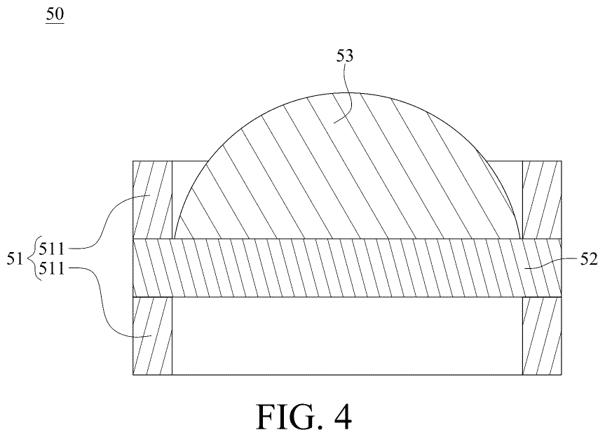

Please refer to FIG. 1 to FIG. 4, where FIG. 2 is a perspective view of one of the damping structures 50 of the electronic device 10 in FIG. 1, FIG. 3 is a plane view of one of the damping structures 50 of the electronic device 10 in FIG. 2, and FIG. 4 is a cross-sectional view of one of the damping structures 50 of the electronic device 10 in FIG. 2.

Each of the damping structures 50 includes a frame 51, a flexible film 52 and a mass block 53. That is, the frame 51, the flexible film 52 and the mass block 53 together form a resonator, and natural frequencies of the resonator follows the equation:

$$f = \frac{1}{2 π} \sqrt{\frac{k}{m}} ,$$

where the symbol “f” in the aforementioned equation refers to the natural frequencies (unit: hertz, Hz) of the resonator, the symbol “k” in the aforementioned equation refers to a stiffness (unit: newtons per meter, N/m) of the flexible film 52, and the symbol “m” in the aforementioned equation refers to a mass (unit: kilograms, kg) of the mass block 53. Furthermore, the less the stiffness of the flexible film 52 is, the lower the natural frequencies of the resonator are. In addition, the greater the mass of the mass block 53 is, the lower the natural frequencies of the resonator are.

The frame 51 is configured to be disposed in the chassis 20. The flexible film 52 is disposed on the frame 51. A periphery of the flexible film 52 is connected to the frame 51. Specifically, the frame 51 includes two clamping portions 511. The two clamping portions 511 are spaced apart from each other. The flexible film 52 is clamped between the two clamping portions 511. The frame 51 is made of, for example, plastic material, and the flexible film 52 is made of, for example, rubber material. Specifically, the frame 51 is made of, for example, a plastic material having a Young's modulus of 2.2 GPa, a Poisson's ratio of 0.375, and a density of 1000 kg/m³. The flexible film 52 is made of, for example, a silicone rubber material having a Young's modulus of 0.3 MPa, a Poisson's ratio of 0.49, and a density of 1150 kg/m³. Since a stiffness of the frame 51 is greater than the stiffness of the flexible film 52, the interaction effect between the frame 51 and the flexible film 52 can be reduced, thereby realizing a broadband vibration suppression effect.

On the other hand, the flexible film 52 made of the silicone rubber material has low electrical conductivity and high damping capacity. An adverse effect on internal circuits (not shown) of the electronic device 10 can be prevented via the low conductivity of the flexible film 52 when the internal circuits of the electronic device 10 are accidentally in contact with the flexible film 52. The flexible film 52 having the high damping capacity can absorb and dissipate the vibrations within a wider frequency range effectively.

The mass block 53 is, for example, hemispherical, and is disposed on the flexible film 52. Specifically, the mass block 53 is located on the flexible film 52 without being in contact with the frame 51 to absorb the vibrations of the high frequency, but the invention is not limited thereto. In other embodiments, the mass block may be in contact with the frame to absorb the vibrations of the low frequency. The two clamping portions 511 surround the mass block 53. When the vibrations generated by the fan 40 during operation are transferred to the damping structures 50, the mass block 53 can absorb the vibrations by freely vibrating along multiple directions on the flexible film 52 to generate the resonance. That is, the damping structures 50 of this embodiment each are a kind of three-dimensional damping system which has multiple natural frequencies and swinging modes. The thinner the flexible film 52 is, the lower stiffness the flexible film 52 is, and thus, the lower the natural frequencies of the resonators are. Moreover, the mass block 53 with the mass and the flexible film 52 corresponding to the actual vibration may be adopted.

In the preferred embodiment, under a condition where one of the natural frequencies of the damping structures 50 is ranging from 300 Hz to 400 Hz, the mass of the mass block 53 may be 150 grams, a spherical radius of the mass block 53 may be approximately 9 millimeters, and a thickness of the flexible film 52 may be approximately 5 mm. The aforementioned design of the damping structures 50 allows the mass block 53 to freely vibrate on the flexible film 52, such that the damping structures 50 can absorb the vibrations generated by the fans 40 during operation via the resonance effectively. The mass and a size of the mass block 53 and the thickness of the flexible film 52 can be adjusted based on an actual vibration frequency to ensure that the natural frequencies of the damping structures 50 can match the vibration frequency of the fans 40, thereby realizing an optimal damping effect.

In this embodiment, the flexible film 52 is clamped between the two clamping portions 511, and the mass block 53 is disposed on the flexible film 52. The natural frequencies of the damping structures 50 can be correspondingly adjusted by adjusting the mass of the mass block 53. Therefore, the vibrations can be damped by the damping structures 50 of the electronic device 10 effectively under different operating conditions. When one of the natural frequencies of the damping structures 50 matches the vibration frequency of the fans 40, a resonance will be generated, and the strong amplitude enhancement effect may be generated by the damping structures 50. The interaction between the vibrations generated by the fans 40 during operation and the flexible film 52 of the damping structures 50 can be conducted along the path in which the vibrations are transferred. Specifically, the vibrations generated by the fans 40 during operation may be transferred to the flexible film 52 of the damping structures 50. The flexible film 52 can absorb the vibrations effectively, and convert the vibrations into kinetic energy of the flexible film 52. Accordingly, the vibrations generated by the fans 40 during operation can be confined within the damping structures 50 to dissipate energy. In addition, the damping structures 50 can be facilitated to be assembled in the limited space between the hard disk drive 30 and the fans 40 and be prevented from interfering with other obstructions disposed in the aforementioned space, and thus, the damping structures 50 can be adaptable to different specifications of the chassis 20. Accordingly, the assembly cost of the damping structures 50 can be lowered while maintaining the damping effect of the damping structures 50.

In this embodiment, there are multiple fans 40 and multiple damping structures 50, but the invention is not limited thereto. In other embodiments, there may be one fan and one damping structure merely.

In this embodiment, the frame 51 includes the two clamping portions 511 spaced apart from each other, and the flexible film 52 is clamped between the two clamping portions 511, but the invention is not limited thereto. In other embodiments, the two clamping portions may be connected to each other and together clamp the flexible film. Alternatively, the frame may have an integral and continuous surface located on an inner side thereof instead of including the two clamping portions, and the periphery of the flexible film is connected to the surface of the inner side of the frame.

In this embodiment, the mass block 53 is hemispherical, but the invention is not limited thereto. In other embodiments, the mass block may be in other shapes.

According to the damping structure and the electronic device disclosed in the above embodiment, the flexible film is clamped between the two clamping portions, and the mass block is disposed on the flexible film. The natural frequencies of the damping structures can be correspondingly adjusted by adjusting the mass of the mass block. Therefore, the vibrations can be damped by the damping structures of the electronic device effectively under different operating conditions. When one of the natural frequencies of the damping structures matches the vibration frequency of the fans, the resonance will be generated, and the strong amplitude enhancement effect may be generated by the damping structures. The interaction between the vibrations generated by the fans during operation and the flexible film of the damping structures can be conducted along the path in which the vibrations are transferred. Specifically, the vibrations generated by the fans during operation may be transferred to the flexible film of the damping structures. The flexible film can absorb the vibrations effectively, and convert the vibrations into kinetic energy of the flexible film. Accordingly, the vibrations generated by the fans during operation can be confined within the damping structures to dissipate energy. In addition, the damping structures can be facilitated to be assembled in the limited space between the hard disk drive and the fans and be prevented from interfering with other obstructions disposed in the aforementioned space, and thus, the damping structures can be adaptable to different specifications of the chassis. Accordingly, the assembly cost of the damping structures can be lowered while maintaining the damping effect of the damping structures.

In this embodiment, the damping structures of the invention can be applied to a server. The server can apply artificial intelligence (AI) computing, edge computing, and can also be used as a 5G server, a cloud server or a Vehicle-to-everything server.

It will be apparent to those skilled in the art that various modifications and variations can be made to the invention. It is intended that the specification and examples be considered as exemplary embodiments only, with the scope of the invention being indicated by the following claims.

What is claimed is:

1. A damping structure, configured to be disposed in a chassis and comprising:
a frame, configured to be disposed in the chassis;
a flexible film, disposed on the frame, wherein a periphery of the flexible film is connected to the frame; and
a mass block, disposed on the flexible film, wherein the frame surrounds the mass block.

2. The damping structure according to claim 1, wherein the frame comprises two clamping portions, and the flexible film is clamped between the two clamping portions.

3. The damping structure according to claim 2, wherein the two clamping portions are spaced apart from each other.

4. The damping structure according to claim 1, wherein the mass block is hemispherical.

5. The damping structure according to claim 1, wherein the frame is made of plastic material, and the flexible film is made of rubber material.

6. An electronic device, comprising:
a chassis;
a hard disk drive, disposed in the chassis;
at least one fan, disposed in the chassis; and
at least one damping structure, located between the hard disk drive and the at least one fan and comprising:
a frame, disposed in the chassis;
a flexible film, disposed on the frame, wherein a periphery of the flexible film is connected to the frame; and
a mass block, disposed on the flexible film, wherein the frame surrounds the mass block.

7. The electronic device according to claim 6, wherein the frame comprises two clamping portions, and the flexible film is clamped between the two clamping portions.

8. The electronic device according to claim 7, wherein the two clamping portions are spaced apart from each other.

9. The electronic device according to claim 6, wherein the mass block is hemispherical.

10. The electronic device according to claim 6, wherein the frame is made of plastic material, and the flexible film is made of rubber material.
